(19) United States
(12) Patent Application Publication
(10) Pub. No.: US 2025/0123395 A1
(43) Pub. Date: Apr. 17, 2025

(54) ACQUIRING AND ILLUMINATING A COOPERATIVE TARGET WITH A LASER BEAM FROM A REMOTE SOURCE

(71) Applicant: The Aerospace Corporation, El Segundo, CA (US)

(72) Inventors: Steven M. BECK, Palos Verdes Estates, CA (US); Gary L. LOPER, Huntington Beach, CA (US)

(73) Assignee: The Aerospace Corporation, El Segundo, CA (US)

(21) Appl. No.: 18/487,544

(22) Filed: Oct. 16, 2023

(51) Int. Cl. G01S 17/66; G01S 17/74; G01S 17/87

(52) U.S. Cl. CPC G01S 17/66; G01S 17/74; G01S 17/87

(57) ABSTRACT

Acquiring and illuminating a cooperative target with a laser beam from a remote source is disclosed. The process may be used for cooperative target tracking where the source/target are a ground station, an aircraft, UAV, drone, satellite, spacecraft, combinations thereof, etc. A laser beam can be rapidly and accurately pointed by an emitter source using a laser pointing system, such as a gimbal or other laser pointing device, for example. A differential GPS on the cooperative target detects its position and periodically sends this information either directly or indirectly to the laser emitter source. The cooperative target may also determine its attitude. The emitter source uses this information to keep the cooperative target illuminated with the laser beam. The system may be used for detection and tracking of atmospheric differential absorptions to detect, track, and mitigate atmospheric releases of global warming gases and toxic industrial chemicals, communication, surveying, lidar, etc.

### FIELD

The present invention generally pertains to target tracking, and more particularly, to acquiring and illuminating a cooperative target with a laser beam from a remote source.

### BACKGROUND

Current target tracking technologies use optical tracking algorithms (e.g., through a telescope and a focal plane detector) to locate, track, and direct a laser pointer. Alternatively, a light beacon mounted on the target with a focal plane receiver (e.g., a camera) located on the laser platform may be used for optical communication applications. However, various limitations exist in the current state-of-the art. Optical tracking techniques require continuous, clear line of site (LOS) from the laser platform or tracking platform to the target. Thus, if a tree, a building, a tower, a cloud, or some other obstruction were to occur between the target and the laser platform or tracking system, tracking would be lost. Reacquiring tracking would be difficult. In fact, even the initial acquisition of the target is difficult from such a system. Similar limitations occur for the light beacon technique.

In addition, many optical backgrounds exist, especially during daytime. This makes optical tracking and light beacon tracking difficult, even with the use of narrowband filters. Optical tracking of cold targets at night is also difficult given the lack of illumination of the target by sunlight or strong thermal infrared (IR) signatures. Previous approaches also rely on knowledge of the orbit or flight path. Accordingly, an improved and/or alternative approach may be beneficial.

### SUMMARY

Certain embodiments of the present invention may be implemented and provide solutions to the problems and needs in the art that have not yet been fully solved by existing target tracking technologies. For example, some embodiments pertain to acquiring and illuminating a cooperative target with a laser beam from a remote source.

In an embodiment, a method for acquiring and illuminating a cooperative target system with a laser beam from a laser source system includes determining, by the cooperative target system, a position and an attitude of the cooperative target system using a differential global positioning system (GPS) and onboard inertial sensors, respectively, of the cooperative target system. The method also includes transmitting, by the cooperative target system, the determined position and attitude of the cooperative target system to the laser source system using a radio frequency (RF) transceiver via an RF link and receiving the transmitted position and attitude from the cooperative target system, by an RF transceiver of the laser source system. The method further includes calculating an aim position of a laser pointing system (e.g., a gimbal) mounted to the laser source system to the cooperative target system using the received position and attitude from the cooperative target system and adjusting the laser pointing system to the aim position, by the laser source system. Additionally, the method includes emitting the laser beam along a line-of-sight from the laser source system to the cooperative target system, by the laser source system.

In another embodiment, a method for acquiring and illuminating a cooperative target system with a laser beam from a laser source system includes transmitting, by a cooperative target system, a position and an attitude of the cooperative target system to the laser source system via an RF link. The method also includes receiving the transmitted position and attitude from the cooperative target system, by the laser source system. The method further includes calculating an aim position of a laser gimbal to the cooperative target system using the received position and attitude from the cooperative target system and adjusting the laser gimbal to the aim position, by the laser source system. Additionally, the method includes directing the laser beam along a LOS from the laser source system to the cooperative target system, by the laser source system.

In yet another embodiment, a method for acquiring and illuminating a cooperative target system with a laser beam from a laser source system includes receiving a position and attitude from the cooperative target system, by the laser source system. The method also includes calculating an aim position of a laser gimbal to the cooperative target system using the received position and attitude from the cooperative target system and adjusting the laser gimbal to the aim position, by the laser source system. The method further includes directing the laser beam along a LOS from the laser source system to the cooperative target system, by the laser source system.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a system with various laser emitter source and cooperative target combinations, according to an embodiment of the present invention.

FIG. 2 is an architectural diagram illustrating a laser emitter source system, according to an embodiment of the present invention.

FIG. 3 is an architectural diagram illustrating a cooperative target system, according to an embodiment of the present invention.

FIG. 4 is an architectural diagram illustrating a combination of a laser emitter source and a cooperative target system where the target system employs retroreflector(s) or corner cube(s) to reflect laser light transmitted from the laser emitter source back to light detector(s) located on the laser emitter source, according to an embodiment of the present invention.

FIG. 5 is a flowchart illustrating a process for acquiring and illuminating a cooperative target with a laser beam from a remote source, according to an embodiment of the present invention.

FIG. 6 is an architectural diagram illustrating a computing system configured to perform operations of a laser emitter source or a cooperative target, according to an embodiment of the present invention.

Unless otherwise indicated, similar reference characters denote corresponding features consistently throughout the attached drawings.

### DETAILED DESCRIPTION OF THE EMBODIMENTS

Some embodiments of the present invention pertain to acquiring and illuminating a cooperative target with a laser beam from a remote source. Some embodiments may be used for cooperative target tracking where the source/target are a ground station, an aircraft, unmanned aerial vehicle (UAV), drone, satellite, spacecraft, any combination thereof, etc. For instance, some embodiments may be used to enable the laser remote sensing concept described in U.S. Pat. No. 8,823,938, which pertains to tracking atmospheric differential absorption (TADA).

Some embodiments can rapidly and accurately point the laser beam using a laser pointing system, such as a gimbal or other laser pointing device, for example. The source may be stationary or in motion, as can the target. Due to the narrow beam characteristic of a laser, it is difficult to hit, and in particular, continuously illuminate a remote target with the laser beam, especially if the target, source, or both are in motion.

To address this problem, some embodiments employ a differential global positioning system (GPS) on the target (e.g., a real time kinematic (RTK) GPS system) that is capable of centimeter-scale three dimensional (3D) spatial measurements at 10 hertz (Hz) or higher rates and broadcasting that information to a laser pointing system remote from the target. Such a GPS can locate the position in Cartesian coordinates or some other coordinate system in space. The target may also carry one or more inertial sensors (e.g., an inertial measurement unit (IMU), accelerometers, gyroscopes, etc.) to determine platform attitude, if desired or required. The laser source platform should also have knowledge of or measure its own location and attitude in real time using a combination of differential sensors (e.g., RTK GPS) and inertial sensors, if moving.

With the two locations in space known simultaneously, and the attitudes of the target and laser source platform also known, a solution for pointing the laser at the target can be derived. For this concept to work, the target should carry an RTK GPS system or other differential GPS device to accurately measure location, as well as a radio transmitter to broadcast the position signal to the laser pointing platform. The laser pointing platform should carry a receiver to receive the broadcast signal from the target, as well as a mechanism to accurately point a laser (e.g., a gimbal-see, for example, U.S. Pat. Nos. 10,494,095 and 11,161,630).

In operation, the target sends its location to the source (emitter), and the source points the emitter laser beam accordingly (i.e., by aligning the source/target with one another along a line segment between their locations as endpoints of the line segment in the selected coordinate system such that laser beam(s) emitted by the source reach(es) the target). Some embodiments may be used for laser communications, for example, and there are handshake protocols that allow the pointing and acquisition to take place.

In some embodiments, once the target has been illuminated by the source laser beam, the target detects the angle of the laser beam using a position sensitive photodetector, for example. Once this angle is determined, the target returns a laser beam along that pointing angle back to the source using its own gimbal-mounted laser pointing system or some other system for accurately pointing a laser. The source then detects the target laser beam using a laser detector, establishing a laser link between the source and target, which can then be used to transmit data through a modulation scheme of the two lasers.

Some embodiments may be particularly beneficial for remote sensing applications (e.g., via UAVs). When flying, UAVs may fly an irregular pattern due to the mission that the UAV is flying, object avoidance, etc. Such embodiments may allow the source and target to maintain laser contact for any desired period of time.

A laser unit (or laser units) capable of generating radiation of m wavelengths of light can be used with one or more light detection systems to measure the different absorption strengths of the n atmospheric species (i.e., chemical species in the atmosphere in the form of gases or vapors), where m≥2 for n=1 species and m≥ n when n species are present over the light transmission path between the laser unit(s) and light detection system(s). The different absorption strengths of the n atmospheric species measured at the m laser wavelengths can be analyzed to determine the concentration levels of the n different atmospheric species (e.g., via spectroscopy) for the short period of time that the absorption measurements are performed at the m wavelengths. The ability to repeat these absorption strength measurements for the n species over any desired period of time enables laser remote sensing, such as the laser remote sensing concept described in U.S. Pat. No. 8,823,938, which pertains to tracking atmospheric differential absorption (TADA).

To detect n different atmospheric species, the m laser wavelengths are chosen to measure differences in absorption strengths within the wavelength limits of the absorption features of the n species while also selecting wavelength regions where water vapor and CO₂ atmospheric transmission windows exist. For example, if the detection of methane (CH₄) is of interest, laser wavelengths should be chosen to be both on and off resonance with one or more rotational-vibrational transitions of CH₄ within one of its vibrational bands at wavelengths where possible atmospheric absorption interferences by water vapor, carbon dioxide (CO₂), and other interference sources are minimized (e.g., near 1.65 or 2.33 microns (μm)). The TADA technology, with the appropriate laser source(s), could be applicable to detecting, tracking, and mitigating releases into the atmosphere of chemicals including, but not limited to: (1) methane and other global warming hydrocarbons during oil and natural gas exploration, production, refining, and transportation (pipeline and liquid natural gas (LNG)) operations as well as from inactive drilling sites, landfills, and livestock feedlots; (2) CO₂ and nitrogen oxide (NOx) global warming gases from power plants; and (3) toxic chemical vapor leaks from chemical plants, storage tanks, and as the result of truck or rail chemical transportation accidents.

In order to maintain accurate tracking, the update rate of the position information sent from the target to the source (either directly or indirectly) may be set accordingly (e.g., 10 Hz, 20 Hz, 50 Hz, etc.). Generally speaking, the faster that the source and/or target are moving, the higher the update rate will be. In other words, the update rate may be proportional to the speed of the vehicle(s). Also, most errors in GPS are associated with the ionosphere due to electron density irregularities that can also interrupt the propagation of the GPS signals, known as cycle slips on the carrier phase measurements. As such, standard GPS receivers do not provide adequate accuracy for such embodiments to succeed. Therefore, a differential GPS system such as RTK GPS is used to reduce position errors and allow centimeter scale position accuracies to be obtained.

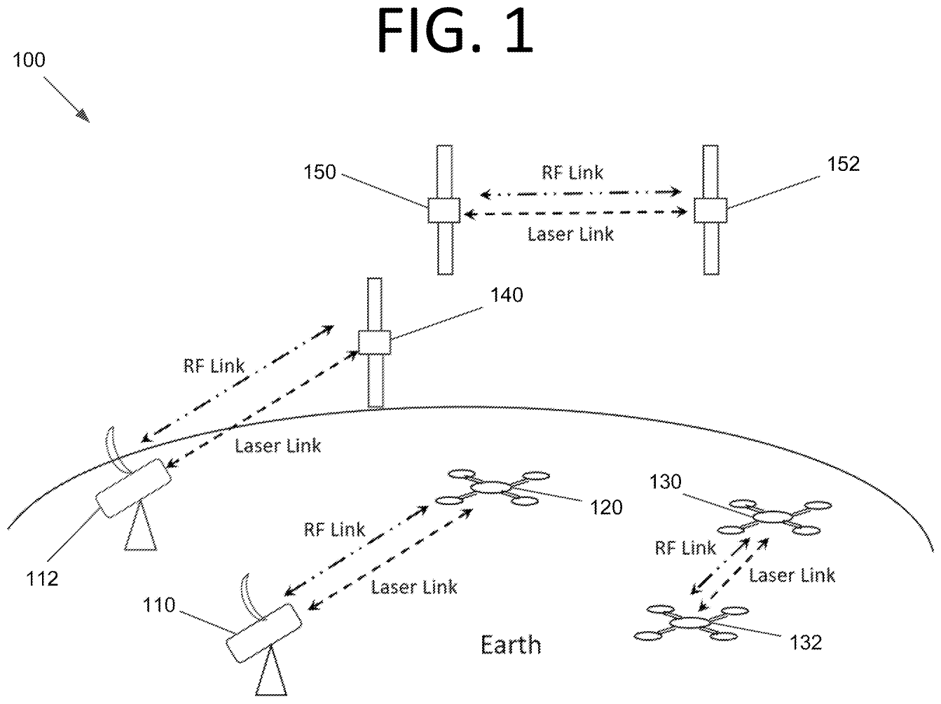

FIG. 1 illustrates a system 100 with various laser emitter source and cooperative target combinations, according to an embodiment of the present invention. System 100 includes ground stations 110, 112, UAVs 120, 130, 132, and satellites 140, 150, 152 (e.g., CubeSats, satellites of other form factors, etc.). The dashed lines represent laser links and RF links. Here, ground station 110 targets and tracks UAV 120, ground station 112 targets and tracks satellite 140, UAV 130 targets and tracks UAV 132, and satellite 150 targets and tracks satellite 152. However, any of ground stations 110, 112, UAVs 120, 130, 132, and satellites 140, 150, 152 may be a source and/or target without deviating from the scope of the invention.

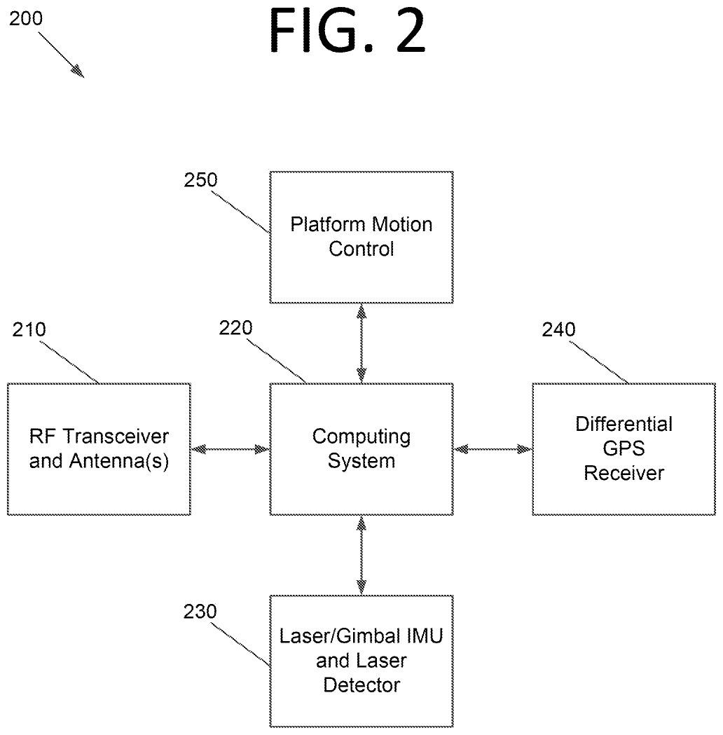

FIG. 2 is an architectural diagram illustrating a laser emitter source system 200, according to an embodiment of the present invention. Laser emitter source system 200 may be part of a ground station, an aircraft, a UAV, a satellite, a spacecraft, or any other suitable platform without deviating from the scope of the invention. Laser emitter source system 200 includes an RF transceiver and antenna(s) 210 that can send/receive RF communications to/from cooperative targets, ground stations, etc. In some embodiments, however, laser emitter source 200 may receive target communications indirectly from another source instead (e.g., via an Internet connection, a local area network (LAN), a cellular network, Wi-Fi, etc.).

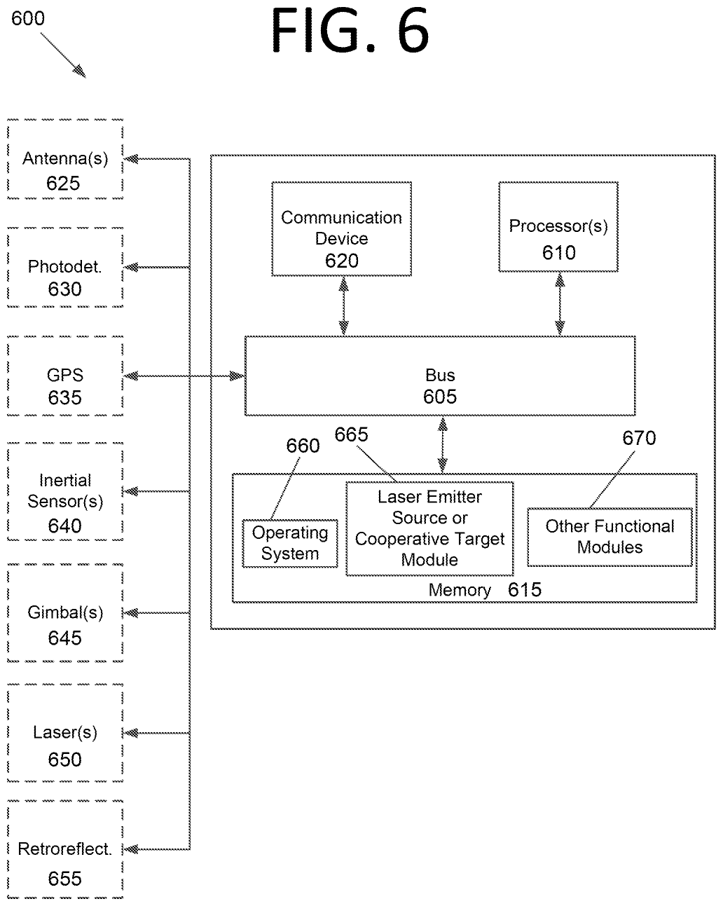

A computing system 220 controls the operations of laser emitter source system 200. In some embodiments, computing system 220 may be computing system 600 of FIG. 6. In this embodiment, computing system 220 controls both the orientation and laser emissions from laser/gimbal IMU 230 (and the orientation of the laser detector, if present). Laser/gimbal IMU 230 includes a laser mounted on a gimbal, and the laser detector of laser/gimbal IMU 230 is communicatively coupled to computing system 220. Computing system 220 also receives and processes location information (e.g., coordinates in a coordinate system) from a differential GPS receiver 240 and controls the movement and orientation of the respective platform using platform motion control 250 (e.g., jet engines, propellers, ion thrusters, solid or liquid propellant rocket engines, etc.).

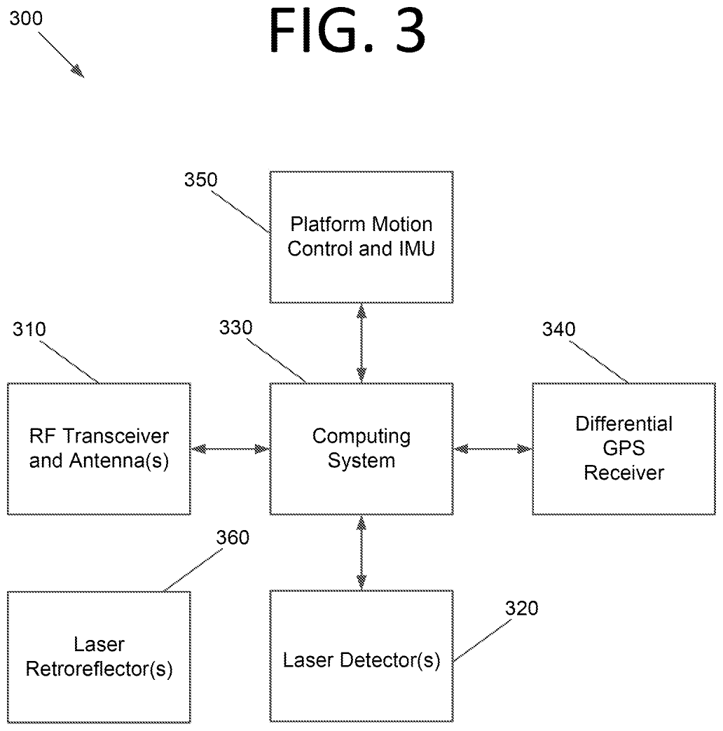

FIG. 3 is an architectural diagram illustrating a cooperative target system 300, according to an embodiment of the present invention. Cooperative target system 300 may be part of a ground station, an aircraft, a UAV, a satellite, a spacecraft, or any other suitable platform without deviating from the scope of the invention. Cooperative target system 300 includes RF transceiver and antenna(s) 310 that can send/receive RF communications to/from laser emitter source systems, ground stations, etc. Laser detector(s) 320 detect laser beam(s) from laser emitter source systems and may be photomultipliers, photoconductors, phototransistors, avalanche photodetectors (APDs), or any other suitable light detecting sensor(s) without deviating from the scope of the invention. When a laser beam from the laser emitter source is detected, laser detector(s) 320 send information pertaining to the detected laser beam (e.g., pulse repetition rate, wavelength, emission pattern information, etc.) to a computing system 330, which controls the operations of cooperative target system 300. In some embodiments, computing system 330 may be computing system 600 of FIG. 6.

Computing system 330 also receives location information from differential GPS receiver 340 and determines attitude and controls platform positioning using platform motion control and IMU 350. Computing system 330 uses the attitude and location information to keep laser detector(s) 320 and/or retroreflector(s) 360 oriented towards the laser emitter source in some embodiments. Computing system 330 also sends its location information to the laser emitter source, either directly or indirectly, via RF transceiver and antenna(s) 310. Computing system 330 continues to periodically send the location of the platform associated with cooperative target system 300 until tracking is no longer desired. In some embodiments, cooperative target platform 300 and the laser emitter source also agree on a periodic location update rate based on factors such as the speed of the laser emitter source and/or cooperative target platform 300, the distance between the laser emitter source and/or cooperative target platform 300, etc.

Depending on the operating environment and locations of the laser emitter source and cooperative target system 300, illumination of laser detector(s) 320 may be interrupted. Cooperative target system 300 may inform the laser emitter source if laser detection no longer occurs for a period of time (e.g., the path to the cooperative target has become blocked by an obstacle, the cooperative target is below the horizon with respect to the laser emitter source, etc.). The period of time may be a tenth of a second, a second, ten seconds, a minute, etc. In some embodiments, cooperative target system 300 and/or laser emitter source may maneuver and try to change their location(s) in an attempt to reestablish laser contact.

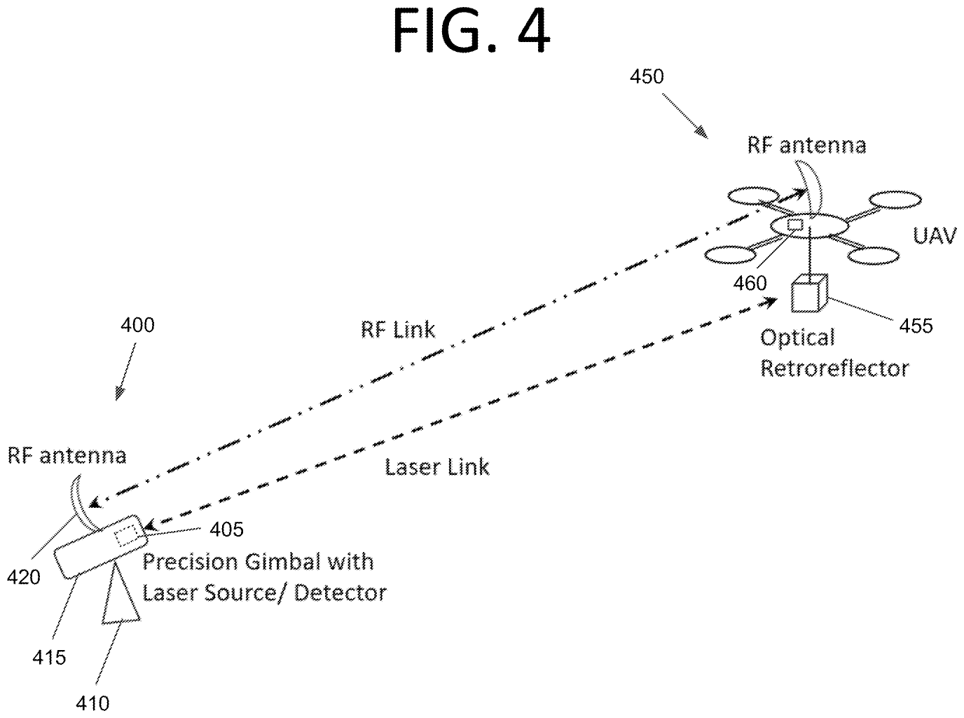

FIG. 4 is an architectural diagram illustrating the use of both a laser/gimbal emitter source system 400 and a cooperative target vehicle system 450, according to an embodiment of the present invention. Cooperative target vehicle system 450 includes one or more retroreflector(s) 455, such as corner cube(s) with retroreflective tape. In this embodiment, differential absorption measurements are made to determine the levels of atmospheric species of interest present over the transmission path from the laser/gimbal emitter source 400 to retroreflector or corner cube 455 on the target vehicle 450, and upon reflection from retroreflector(s) 455, transmission of the reflected light back to photodetector(s) 405 located close to precision gimbal 410 and laser source(s) 415 on emitter source vehicle 400. Laser emitter source system 400 and cooperative target system 450 may separately be part of a ground station, an aircraft, a UAV, a satellite, a spacecraft, or any other suitable platform without deviating from the scope of the invention. Laser emitter source system 400 includes RF antenna(s) 420 that can receive RF communications from cooperative targets, ground stations, etc. In some embodiments, however, laser emitter source 400 may not include RF antennas and may receive target communications indirectly from another source (e.g., via an Internet connection, a LAN, a cellular network, Wi-Fi, etc.).

Cooperative target system 450 includes photodetector(s) 460 that can detect laser emissions from laser emitter source system 400. Photodetector(s) 460 may be photomultipliers, photoconductors, phototransistors, APDs, or any other suitable light detecting sensor without deviating from the scope of the invention. When a laser beam from the laser emitter source is detected, photodetector(s) 460 send information pertaining to the detected laser beam (e.g., pulse repetition rate, wavelength, emission pattern information, etc.) to a computing system (not shown, but may be computing system 330 or 600 of FIGS. 3 and 6, for example), which controls the operations of the cooperative target system 450 supporting an attached retroreflector (or corner cube) 455. The computing system receives and processes location information (e.g., coordinates in a coordinate system) from a differential GPS (not shown, but may be differential GPS 340 or 635 of FIGS. 3 and 6, for example) and determines the attitude of the attached retroreflector or corner cube using inertial information from inertial sensor(s) (not shown, but may be those of FIG. 3 or 6, for example).

In this embodiment, another computing system (e.g., computing system 220 or 600 of FIGS. 2 and 6) controls both the orientation and laser emissions from laser emitter source system 400, which is communicatively coupled to the computing system of cooperative target system 450. Initially, the computing system of laser emitter source system 400 causes precision gimbal 410 and laser source(s) 415 to perform a laser dithering routine to attempt to hit cooperative target system 450. After cooperative target system 450 detects the laser beam from laser source(s) 415, cooperative target system 450 sends a communication with its location. This target location information is received by antenna(s) 420 or another communication mechanism associated with the computing system of laser emitter source system 400, and the computing system adjusts the orientation of laser emitter source system 400 accordingly. Laser emitter source system 400 then continues to illuminate cooperative target system 450 using precision gimbal 410 and laser source(s) 415 and continues to adjust the orientation of precision gimbal 410 and laser source(s) 415 based on periodically received location updates from cooperative target system 450 until tracking of cooperative target system 450 is no longer desired or cooperative target system 450 moves out of LOS (e.g., a cooperative target satellite orbits below the horizon).

The computing system of cooperative target system 450 receives and processes location information (e.g., coordinates in a coordinate system) from its GPS and determines attitude using inertial information from its inertial sensor(s). The computing system uses the attitude and location information to keep both photodetector(s) 460 and retroreflectors (or corner cubes) 455 mounted on cooperative target system 450 oriented towards laser emitter source system 400.

Once retroreflector or corner cube 455 mounted on cooperative target system 450 is illuminated with laser radiation from the laser emitter source system 400, the computing system of cooperative target system 450 causes retroreflector or corner cube 455 to perform a dithering routine such that the laser light reflected therefrom is detected by photodetector(s) 405 located on laser emitter source system 400. The computing system of cooperative target system 450 sends a communication to laser emitter source system 400 specifying the location of photodetector(s) 460. The location information for photodetector(s) 460 is received by RF antenna(s) 420 or another communication mechanism associated with laser emitter source system 400 so it can point laser source(s) 415 towards photodetector(s) 460. The computing system of cooperative target system 450 adjusts the orientation of retroreflector or corner cube 455 accordingly and continues to adjust the orientation so that the laser light reflected from retroreflector or corner cube 455 is maintained in optical alignment with photodetector(s) 405 on laser emitter source system 400.

Precision gimbal 410 and laser source(s) 415 mounted on laser emitter source system 400 are capable of generating radiation of m wavelengths of light that can be used with photodetector(s) 405 to measure the different absorption strengths of the n atmospheric species present over the round trip light transmission path between the laser unit(s) to retroreflector or corner cube 455 and (upon reflection therefrom) transmission back to photodetector(s) 405 located on laser emitter source system 400. The different absorption strengths of the n atmospheric species measured at the m laser wavelengths can be analyzed to determine the concentration levels of the n different atmospheric species for the short period of time the absorption measurements are performed at the m wavelengths. Depending on the operating environment and locations of laser emitter source system 400 and cooperative target system 450, illumination of photodetector(s) 405 or 460 may be interrupted. Cooperative target system 450 may inform laser emitter source system 400 if laser detection no longer occurs for a period of time (e.g., the path between cooperative target system 450 and laser emitter source system 400 has become blocked by an obstacle, cooperative target system 450 is below the horizon with respect to laser emitter source system 400, etc.). The period of time may be a tenth of a second, a second, ten seconds, a minute, etc. In some embodiments, laser emitter source system 400 and/or cooperative target system 450 may maneuver and try to change their respective location(s) in an attempt to reestablish laser contact.

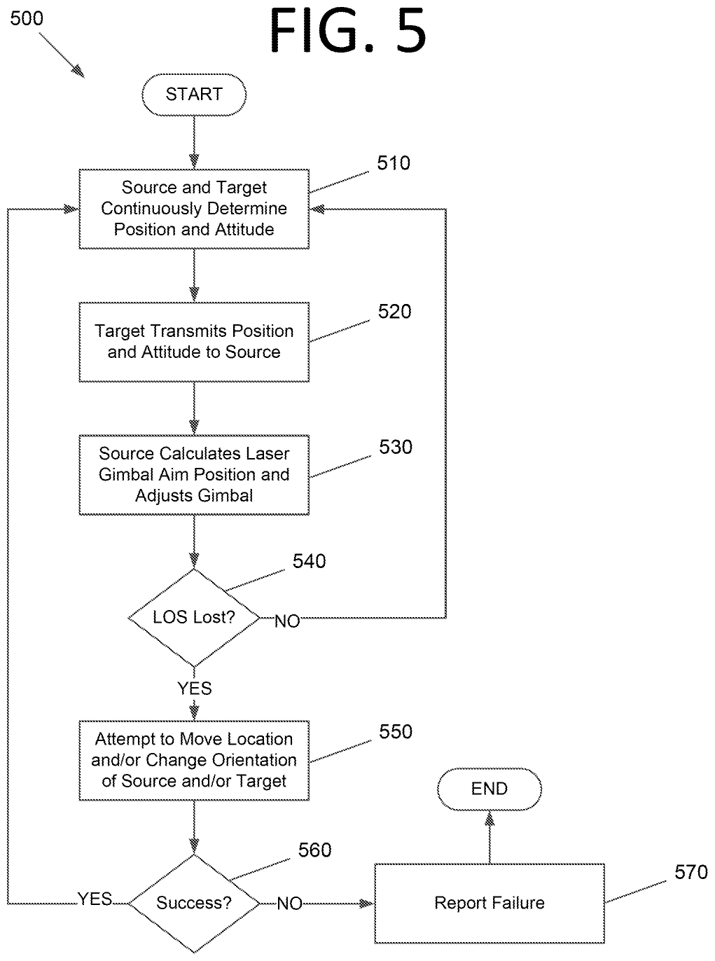

FIG. 5 is a flowchart illustrating a process 500 for acquiring and illuminating a cooperative target with a laser beam from a remote source, according to an embodiment of the present invention. The process begins with the source and target determining their respective positions and attitudes at 510 using their respective differential GPSs and IMUs. However, in embodiments where the source is not moving (e.g., the source is a ground station), this may not be required for the source. The cooperative target may record its 3D position in a common and appropriate frame of reference or coordinate system using the differential GPS, which is capable of determining absolute position to within one to two centimeters accuracy in three orthogonal axes. In addition to its position, the source and/or target, if required, records its 3D attitude using on-board inertial sensors such as gyros and accelerometers.

Once its position is known, the target transmits its position and attitude to the source at 520 using an RF transceiver via an RF link. The source receives this information via its own respective RF transceiver. Based on the positions and attitudes of the source and the target, the source calculates its laser gimbal aim position to the target and adjusts the laser gimbal to that position at 530. In other words, using this information, the target calculates an LOS direction from the source to the target using its computing system. By doing so, the source directs a laser beam, either using the gimbal or some other means of pointing a laser beam, along the calculated LOS from the source to the target.

If LOS to the target is not lost at 540, the process (continuously or periodically) returns to step 510 and repeats. However, if the LOS from the source to the target is lost or the laser reflection from the target is otherwise no longer received by the source at 540, the source and/or the target change their location(s) and/or orientation(s) at 550 in an attempt to reestablish illumination of the target by the source. This may be coordinated via the RF link, if still available. If contact is reestablished at 560, the process returns to step 510 and repeats. Otherwise, failure is reported at 570 so a human operator can attempt to determine the cause.

The sequence of steps 510-530 may be repeated as often as the following equation for repetition rate v requires:

$$v = \frac{2 {V}_{T}}{{D}_{L}} \qquad ( 1 )$$

where V_{T} is the target relative vehicle velocity perpendicular to the laser propagation direction and D_{L} is the diameter of the laser spot at the target (assuming a circular beam shape at the target), given by:

$${D}_{L} = {σ}_{L} R \qquad ( 2 )$$

where σ_{L} is the divergence angle of the laser in radians and R is the range from the source to the target (e.g., in meters). V_{T} should take into account both the source and target velocity so as to know the speed at which the target crosses the laser beam spot.

If the target also carries a laser source and system for accurately pointing the laser, such as if the source and target are to form a laser communication link, the target should record the angle of arrival of the source laser beam using a focusing lens and a position sensitive detector, for example, calculate a pointing angle based on the arrival angle of the source laser beam and the current position and attitude of the target, and point a return laser beam back to the source using the laser pointing system of the target, such as a gimbal.

FIG. 6 is an architectural diagram illustrating a computing system 600 configured to perform operations of an emitter source or a cooperative target, according to an embodiment of the present invention. In some embodiments, computing system 600 may be one or more of the computing systems depicted and/or described herein. Computing system 600 includes a bus 605 or other communication mechanism for communicating information, and processor(s) 610 coupled to bus 605 for processing information. Processor(s) 610 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 610 may also have multiple processing cores, and at least some of the cores may be configured to perform specific functions. Multi-parallel processing may be used in some embodiments. In certain embodiments, at least one of processor(s) 610 may be a neuromorphic circuit that includes processing elements that mimic biological neurons. In some embodiments, neuromorphic circuits may not require the typical components of a Von Neumann computing architecture.

Computing system 600 further includes a memory 615 for storing information and instructions to be executed by processor(s) 610. Memory 615 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 610 and may include volatile media, non-volatile media, or both. The media may also be removable, non-removable, or both. Computing system 600 includes a communication device 620, such as a transceiver, to provide access to a communications network via a wireless and/or wired connection. In some embodiments, communication device 620 may include one or more antennas that are singular, arrayed, phased, switched, beamforming, beamsteering, a combination thereof, and or any other antenna configuration without deviating from the scope of the invention.

Processor(s) 610 are further coupled via bus 605 to RF antenna(s) 625, photodetector(s) 630, differential GPS 635, inertial sensor(s) 640, gimbal(s) 645, laser(s) 650, and/or retroreflector(s) 655. Which of these components is included depends on whether computing system 600 is part of a laser emitter source platform or a cooperative target platform, the type of the platform, whether the platform is moving, etc. Memory 615 stores software modules that provide functionality when executed by processor(s) 610. The modules include an operating system 660 for computing system 600. The modules further include a laser emitter source or cooperative target module 665 that is configured to perform the operations of the respective source or target system. Computing system 600 may include one or more additional functional modules 670 that include additional functionality.

One skilled in the art will appreciate that a “system” could be embodied as an embedded computing system, a flight computer, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIG. 5 may be performed by a computer program, encoding instructions for the processor(s) to perform at least part of the process(es) described in FIG. 5, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 610 of computing system 600 of FIG. 6) to implement all or part of the process steps described in FIG. 5, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for acquiring and illuminating a cooperative target system with a laser beam from a laser source system, comprising:
determining, by the cooperative target system, a position and an attitude of the cooperative target system using a differential global positioning system (GPS) and onboard inertial sensors, respectively, of the cooperative target system;
transmitting, by the cooperative target system, the determined position and attitude of the cooperative target system to the laser source system using a radio frequency (RF) transceiver via an RF link;
receiving the transmitted position and attitude from the cooperative target system, by an RF transceiver of the laser source system;
calculating an aim position of a laser pointing system mounted to the laser source system to the cooperative target system using the received position and attitude from the cooperative target system and adjusting the laser pointing system to the aim position, by the laser source system; and
directing the laser beam along a line-of-sight (LOS) from the laser source system to the cooperative target system, by the laser source system.

2. The method of claim 1, further comprising:
measuring, by the laser source system, a position and attitude of the laser source system using a differential GPS and onboard inertial sensors, respectively, of the laser source system or recording, by the laser source system, the position and the attitude of the laser source system when known; and
using the measured or known position and attitude of the laser source system with the position and attitude from the cooperative target system to calculate the aim position of the laser pointing system to the cooperative target system to adjust the laser pointing system to the aim position, by the laser source system.

3. The method of claim 1, wherein the measuring or recording of the position of the cooperative target system comprises measuring or recording a three dimensional (3D) position in a common frame of reference or coordinate system using the differential GPS.

4. The method of claim 1, wherein responsive to losing the LOS from the laser source system to the cooperative target system, the method further comprises:
changing a location and/or orientation of the laser source system, changing a location and/or orientation of the cooperative target system, or both;
calculating an aim position of the laser pointing system to the cooperative target system and adjusting the laser pointing system to the aim position, by the laser source system, based on the changed location and/or orientation of the laser source system and/or cooperative target system; and
directing the laser beam along the LOS from the laser source system to the cooperative target system, by the laser source system, wherein
the change in the location and/or orientation of the laser source system, the coordinated target system, or both, is coordinated via the RF link.

5. The method of claim 1, further comprising:
calculating a repetition rate v for repeating the determination of the position and the attitude of the cooperative target system using:
$$v = \frac{2 {V}_{T}}{{D}_{L}}$$
where V_{T} is a relative velocity of the cooperative target system perpendicular to a laser propagation direction of the laser beam and D_{L} is a diameter of a laser spot of the laser beam at the cooperative target system given by:
D_{L}=σ_{L}R
where σ_{L} is a divergence angle of the laser beam and R is a range from the laser source system to the cooperative target system; and
repeating the method of claim 1 with a frequency of the repetition rate.

6. The method of claim 5, wherein V_{T} is selected to take into account velocities of both the laser source system and the cooperative target system to determine a speed at which the cooperative target system crosses the laser spot of the laser beam.

7. The method of claim 1, wherein the cooperative target system comprises a laser source and a laser pointing system and the method further comprises:
recording an angle of arrival of the laser beam from the laser source system, by the cooperative target system;
calculating a pointing angle based on the angle of arrival of the source laser beam from the laser source system and a current position and attitude of the cooperative target system, by the cooperative target system; and
pointing a return laser beam back to the laser source system, by the cooperative target system.

8. The method of claim 1, wherein the differential GPS is a real time kinematic (RTK) GPS system configured to perform centimeter-scale three dimensional (3D) spatial measurements at rates of 10 hertz (Hz) or higher.

9. The method of claim 1, wherein
the laser source system is a ground station, an aircraft, an unmanned aerial vehicle (UAV), a drone, a satellite, or a spacecraft, and
the cooperative target system is a ground station, an aircraft, a UAV, a drone, a satellite, or a spacecraft.

10. The method of claim 1, wherein the laser source system and the cooperative target system are configured to perform detection and tracking of atmospheric differential absorptions to detect, track, and mitigate atmospheric releases of global warming gases and toxic industrial chemicals, provide communications, perform surveying, provide a light detection and ranging (lidar) system, or any combination thereof.

11. The method of claim 1, wherein the laser source system is configured to:
generate radiation at m wavelengths of light to measure absorption strengths of n atmospheric species, m≥2 for n=1 species, and m≥n when n species are present over a light transmission path between the laser source system and the cooperative target system;
measure different absorption strengths of the n atmospheric species at the m laser wavelengths; and
analyze the measured different absorption strengths to determine concentration levels of the n atmospheric species for a period of time that the absorption measurements are performed at the m wavelengths.

12. The method of claim 1, wherein the cooperative target system comprises a retroreflector or a corner cube.

13. The method of claim 12, wherein the laser source system and the cooperative target system are configured to perform a dithering routine such that laser light from the laser beam reflected from the retroreflector or the corner cube is detected by one or more photodetectors of the laser source system.

14. The method of claim 13, wherein the cooperative target system adjusts an orientation of the retroreflector or the corner cube based on location information sent by the laser source system via the RF link and continues to adjust the orientation of the retroreflector or the corner cube so that the laser light reflected from the retroreflector or the corner cube is maintained in optical alignment with the one or more photodetectors of the laser source system.

15. A method, for acquiring and illuminating a cooperative target system with a laser beam from a laser source system, comprising:
transmitting, by a cooperative target system, a position and an attitude of the cooperative target system to the laser source system via a radio frequency (RF) link;
receiving the transmitted position and attitude from the cooperative target system, by the laser source system;
calculating an aim position of a laser pointing system mounted to the laser source system to the cooperative target system using the received position and attitude from the cooperative target system and adjusting the laser pointing system to the aim position, by the laser source system; and
directing the laser beam along a line-of-sight (LOS) from the laser source system to the cooperative target system, by the laser source system.

16. The method of claim 15, further comprising:
determining, by the cooperative target system, the position and the attitude of the cooperative target system using a differential global positioning system (GPS) and an inertial measurement unit (IMU) and onboard inertial sensors, respectively, of the cooperative target system.

17. The method of claim 15, further comprising:
measuring, by the laser source system, a position and attitude of the laser source system using a differential GPS and onboard inertial sensors, respectively, of the laser source system or recording, by the laser source system, the position and the attitude of the laser source system when known; and
using the measured or known position and attitude of the laser source system with the position and attitude from the cooperative target system to calculate the aim position of the laser pointing system to the cooperative target system to adjust the laser pointing system to the aim position, by the laser source system.

18. The method of claim 15, wherein the recording of the position of the cooperative target system comprises recording a three dimensional (3D) position in a common frame of reference or coordinate system using the differential GPS.

19. The method of claim 15, wherein responsive to losing the LOS from the laser source system to the cooperative target system, the method further comprises:
changing a location and/or orientation of the laser source system, changing a location and/or orientation of the cooperative target system, or both;
calculating an aim position of the laser pointing system to the cooperative target system and adjusting the laser pointing system to the aim position, by the laser source system, based on the changed location and/or orientation of the laser source system and/or cooperative target system; and
directing the laser beam along the LOS from the laser source system to the cooperative target system, by the laser source system, wherein
the change in the location and/or orientation of the laser source system, the coordinated target system, or both, is coordinated via the RF link.

20. The method of claim 15, further comprising:
calculating a repetition rate v for repeating the determination of the position and the attitude of the cooperative target system using:
$$v = \frac{2 {V}_{T}}{{D}_{L}}$$
where V_{T} is a relative velocity of the cooperative target system perpendicular to a laser propagation direction of the laser beam and D_{L} is a diameter of a laser spot of the laser beam at the cooperative target system given by:
D_{L}=σ_{L}R
where σ_{L} is a divergence angle of the laser beam and R is a range from the laser source system to the cooperative target system; and
repeating the method of claim 1 with a frequency of the repetition rate.

21. The method of claim 20, wherein V_{T} is selected to take into account velocities of both the laser source system and the cooperative target system to determine a speed at which the cooperative target system crosses the laser spot of the laser beam.

22. The method of claim 15, wherein the cooperative target system comprises a laser source and a laser pointing system and the method further comprises:
recording an angle of arrival of the laser beam from the laser source system, by the cooperative target system;
calculating a pointing angle based on the angle of arrival of the source laser beam from the laser source system and a current position and attitude of the cooperative target system, by the cooperative target system; and
pointing a return laser beam back to the laser source system, by the cooperative target system.

23. The method of claim 15, wherein the laser source system is configured to:
generate radiation at m wavelengths of light to measure absorption strengths of n atmospheric species, m≥2 for n=1 species, and m≥n when n species are present over a light transmission path between the laser source system and the cooperative target system;
measure different absorption strengths of the n atmospheric species at the m laser wavelengths; and
analyze the measured different absorption strengths to determine concentration levels of the n atmospheric species for a period of time that the absorption measurements are performed at the m wavelengths.

24. The method of claim 15, wherein
the cooperative target system comprises a retroreflector or a corner cube, and
the laser source system and the cooperative target system are configured to perform a dithering routine such that laser light from the laser beam reflected from the retroreflector or the corner cube is detected by one or more photodetectors of the laser source system.

25. The method of claim 24, wherein the cooperative target system adjusts an orientation of the retroreflector or the corner cube based on location information sent by the laser source system via the RF link and continues to adjust the orientation of the retroreflector or the corner cube so that the laser light reflected from the retroreflector or the corner cube is maintained in optical alignment with the one or more photodetectors of the laser source system.

26. A method, for acquiring and illuminating a cooperative target system with a laser beam from a laser source system, comprising:
receiving a position and attitude from the cooperative target system, by the laser source system;
calculating an aim position of a laser pointing system mounted to the laser source system to the cooperative target system using the received position and attitude from the cooperative target system and adjusting the laser pointing system to the aim position, by the laser source system; and
directing the laser beam along a line-of-sight (LOS) from the laser source system to the cooperative target system, by the laser source system.

27. The method of claim 26, further comprising:
measuring, by the laser source system, a position and attitude of the laser source system using a differential GPS and onboard inertial sensors, respectively, of the laser source system or recording, by the laser source system, the position and the attitude of the laser source system when known; and
using the measured or known position and attitude of the laser source system with the position and attitude from the cooperative target system to calculate the aim position of the laser pointing system to the cooperative target system to adjust the laser pointing system to the aim position, by the laser source system.

28. The method of claim 26, wherein responsive to losing the LOS from the laser source system to the cooperative target system, the method further comprises:
changing a location and/or orientation of the laser source system, changing a location and/or orientation of the cooperative target system, or both;
calculating an aim position of the laser pointing system to the cooperative target system and adjusting the laser pointing system to the aim position, by the laser source system, based on the changed location and/or orientation of the laser source system and/or cooperative target system; and
directing the laser beam along the LOS from the laser source system to the cooperative target system, by the laser source system, wherein
the change in the location and/or orientation of the laser source system, the coordinated target system, or both, is coordinated via the RF link.

29. The method of claim 26, wherein the cooperative target system comprises a laser source and a laser pointing system and the method further comprises:
recording an angle of arrival of the laser beam from the laser source system, by the cooperative target system;
calculating a pointing angle based on the angle of arrival of the source laser beam from the laser source system and a current position and attitude of the cooperative target system, by the cooperative target system; and
pointing a return laser beam back to the laser source system, by the cooperative target system.

30. The method of claim 26, wherein the laser source system is configured to:
generate radiation at m wavelengths of light to measure absorption strengths of n atmospheric species, m≥2 for n=1 species, and m≥n when n species are present over a light transmission path between the laser source system and the cooperative target system;
measure different absorption strengths of the n atmospheric species at the m laser wavelengths; and
analyze the measured different absorption strengths to determine concentration levels of the n atmospheric species for a period of time that the absorption measurements are performed at the m wavelengths.

31. The method of claim 26, wherein
the cooperative target system comprises a retroreflector or a corner cube,
the laser source system and the cooperative target system are configured to perform a dithering routine such that laser light from the laser beam reflected from the retroreflector or the corner cube is detected by one or more photodetectors of the laser source system, and
the cooperative target system adjusts an orientation of the retroreflector or the corner cube based on location information sent by the laser source system via the RF link and continues to adjust the orientation of the retroreflector or the corner cube so that the laser light reflected from the retroreflector or the corner cube is maintained in optical alignment with the one or more photodetectors of the laser source system.
